(19) United States
(12) Patent Application Publication
(10) Pub. No.: US 2025/0325924 A1
(43) Pub. Date: Oct. 23, 2025

(54) INTEGRATION OF POROUS AND PERMEABLE FEED SPACERS ONTO MEMBRANE SURFACES

(71) Applicant: NEW YORK UNIVERSITY IN ABU DHABI CORPORATION, Abu Dhabi (AE)

(72) Inventors: Yazan Ibrahim, Abu Dhabi (AE); Nidal Hilal, Abu Dhabi (AE)

(73) Assignee: NEW YORK UNIVERSITY IN ABU DHABI CORPORATION, Abu Dhabi (AE)

(21) Appl. No.: 19/182,396

(22) Filed: Apr. 17, 2025

Related U.S. Application Data
(60) Provisional application No. 63/636,617, filed on Apr. 19, 2024.

(51) Int. Cl. B01D 29/01; B01D 29/90; B01D 39/16; B33Y 10/00; B33Y 70/00; B33Y 80/00

(52) U.S. Cl. CPC B01D 29/012; B01D 29/902; B01D 39/16; B33Y 10/00; B33Y 70/00; B33Y 80/00; B01D 2239/0478; B01D 2239/069; B01D 2239/10

(57) ABSTRACT

Porous feed spacers are integrated onto membrane surfaces to enhance filtration performance. The porous feed spacers are 3D printed onto membrane surfaces and are made of polymers used to fabricate membranes, such as polyethersulfone. The integration process leverages the flexibility of direct 3D printing to create any feed spacer shape and seamlessly integrate it to the membrane surface, enhancing water permeation and reducing membrane fouling. The use of membranes created using this method eliminates the need for plastic and non-porous feed spacers.

### CROSS-REFERENCE TO RELATED PATENT APPLICATIONS

This application claims the benefit of and priority to U.S. Provisional Application No. 63/636,617, filed on Apr. 19, 2024, the entire disclosure of which is hereby incorporated by reference herein.

### TECHNICAL FIELD

The present disclosure relates generally to integration of porous and permeable feed spacers onto membrane surfaces.

### BACKGROUND

The growing demand for potable water, coupled with a shortage of fresh water, has positioned sustainable membrane technologies, like reverse osmosis (RO), nanofiltration (NF), ultrafiltration (UF), microfiltration (MF), membrane distillation (MD), and forward osmosis (FO), as essential solutions. The sustainability of these processes is further extended by their potential recyclability. For example, at the end of their lifespan, RO membranes can be repurposed for applications, including MD, FO, and UF in pretreatment processes, among other applications, thus promoting circularity in membrane engineering. Membrane technologies selectively separate mixtures based on properties like size, vapor pressure, or electric charge. Made from materials such as polymers, ceramics, metals, among others, membranes produce a permeate stream of desired components while retaining a reject stream that can be reused to enhance process efficiency. The major challenge of these technologies is membrane fouling that diminishes performance by reducing water flux and increasing energy demands. Fouling occurs when substances like organic matter, biofilms, or minerals accumulate on the membrane surface or within its pores, blocking water flow. This necessitates frequent cleaning and can lead to irreversible damage, shortening the lifespan of the membrane.

Feed channel spacers, commonly used in membrane systems, are net-type structures made from non-porous plastic materials like polypropylene (PP), typically manufactured through plastic extrusion as woven or non-woven forms. Spacers improve membrane systems by increasing flow turbulence, enhancing mass transfer, and reducing membrane fouling through better fluid mixing. They also provide crucial mechanical support to maintain membrane stability during operations.

Innovative designs, including 3D-printed feed spacers with enhanced geometries, aim to mitigate fouling and enhance water permeation, but face limitations near membrane-spacer interaction zones. For instance, their physical contact with the membrane surface causes the formation of the near-zero mass transfer regions. This encourages severe fouling through biofilm growth at these locations. Furthermore, the contact between feed spacers and the membrane surface can result in partial blockage or damage to the delicate active membrane area, particularly when the spacer filaments exert pressure on the membrane.

Recent advancements have focused on membrane surface patterning techniques such as phase separation micromolding (PSμM) and nanoimprint lithography (NIL) to enhance water flux and fouling resistance by altering surface topography. However, these techniques are largely limited to producing patterns in the nano- or micro-scale range and these methods face significant challenges in mold fabrication, scalability, and design flexibility.

Direct 3D printing has been utilized to fabricate non-porous, dense patterned membranes, primarily for ion-exchange membranes (IEM) due to the layer-by-layer deposition process that inherently creates tightly packed structures with limited pore formation. However, there remains a need to develop a membrane fabrication and surface patterning method leveraging 3D printing to produce porous, permeable surface patterns that mimic the design of traditional plastic, non-porous feed spacers.

### SUMMARY

Described herein are the systems and method for fabricating an integrated membrane by integrating porous and permeable feed spacer patterns made of polyethersulfone (PES), or any other polymer used to fabricate membranes (e.g., filtration membranes), directly onto the surfaces of filtration membranes using 3D printing technology. The integration process leverages the flexibility of direct 3D printing to create any feed spacer shape and seamlessly integrate it to the membrane surface, enhancing water permeation and reducing membrane fouling. The integrated membranes, in various embodiments, filters 130% more water than flat unintegrated and/or unpatterned filtration membrane when used with separate non-porous feed spacer. The use of membranes created using this method can eliminate the need for plastic and non-porous feed spacers, a very critical component of the commercial spiral wound membrane (SWM) modules used for seawater desalination.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1A is a cross-sectional schematic diagram of a membrane-based system that utilizes non-porous feed spacer according to an example embodiment. FIG. 1B is a cross-sectional schematic diagram of an integrated membrane-based system that utilizes integrated membrane with porous integrated feed spacer according to an example embodiment.

FIG. 2 is a schematic illustration of a method of fabricating and using direct 3D printing technology to create an integrated membranes with integrated feed spacer patterns, according to an example embodiment.

FIG. 3A is a graph depicting an area fidelity of the integrated membranes, according to various embodiments; and FIG. 3B is an example of 3D-scanned images of the integrated membranes, according to various embodiments.

FIG. 4A shows examination of polymer blend viscosity used in the 3D printing process; and FIG. 4B shows viscosity measurements at a shear rate of 50 s⁻¹.

FIG. 5 shows scanning electron microscope (SEM) images depicting surface assessment of the flat and integrated membranes along with magnified images of the porous feed spacer pattern surface, according to various embodiments.

FIG. 6 shows SEM cross-sectional images of the integrated membranes along with magnified images of the sublayer skeleton, according to various embodiments.

FIG. 7A is a graph of the pure water flux, according to various embodiments; FIG. 7B is a graph showing the measured increase in integrated membranes' surface area when compared to a flat unintegrated and/or unpatterned membrane; FIG. 7C shows surface porosity and pore size; and FIG. 7D shows WCA and surface free energy of the flat and integrated membranes.

FIG. 8A shows force versus displacement curves; FIG. 8B shows thermogravimetric analysis (“TGA”) showing the decomposition temperature; and FIG. 8C shows images of the integrated membranes with porous feed spacers patterns, according to various embodiments.

FIG. 9A shows evaluation of the pressure drop at different velocities; FIG. 9B shows decrease/increase in the pressure with respect to FS18 membrane; and FIG. 9C is a depiction of the turbulence intensification with the increase in feed spacer pattern fidelity.

FIG. 10A is a graph showing the relative flux decline during humic acid (HA) filtration tests of unintegrated/unpatterned membrane with non-porous spacer and integrated membranes with integrated porous feed spacer patterns, according to some embodiment; FIG. 10B shows enlarged image depicting the first hour of HA experiment; FIG. 10C shows HA rejection percentage; and FIG. 10D shows flux recovery ratio after 2 cycles of membrane fouling and subsequent cleaning.

FIG. 11 is a depiction of the potential anti-fouling mechanism in the integrated and FS18 membranes.

FIG. 12 is a schematic illustration of the feed spacer design and geometry used in a 3D printing process, according to an example embodiment.

FIGS. 13A-13F show performance of the membranes in terms of solute rejection (R; %) versus Stokes diameter (DS; nm).

FIG. 14 shows probability density function curves (i.e., pore size distribution) of the flat and integrated membranes.

FIG. 15 illustrates a computer system for use with certain implementations.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Described herein are systems and methods for the fabrication of integrated membranes (e.g., integrated filtration membranes) through direct 3D printing of patterns (e.g., PES patterns) onto flat membranes. For example, the patterns can be porous feed spacer patterns. These surface patterns mimic the shape of non-porous feed spacers, eliminating the need for separate non-porous feed spacers in membrane filtration systems. It also eliminates the need for replica molds, which is a common requirement in many surface patterning techniques.

A filtration membrane can include a selectively permeable material or structure that allows the passage of specific substances, such as molecules, ions, or particles, while preventing the passage of others. The selective permeability is based on one or more factors, including but not limited to, size, charge, chemical properties, or other physical characteristics of the substances. The membrane's functionality is leveraged in processes such as filtration, separation, and purification in various industrial, chemical, and biological applications.

A feed spacer can be a structural element used in membrane filtration systems to maintain a uniform spacing between adjacent membranes in a filtration module. The feed spacer allows for the flow of feed solution across the membrane surface, promoting optimal fluid distribution and preventing membrane fouling. The feed spacer can help to create turbulent flow within the filtration channel, improving mass transfer and enhancing the overall efficiency of the filtration process. Feed spacers are often incorporated as separate components within membrane filtration modules.

An integrated membrane (IM) can include a membrane structure in which a single or multiple functional components, such as the membrane material and supporting or spacing elements, are combined into a single, unified system. This integration eliminates the need for separate components, such as feed spacers, by incorporating components directly into the membrane's surface or structure. The IM maintains the desired functionality, such as selective permeability, while improving efficiency and minimizing the number of components required in membrane filtration or separation processes.

In this method, a flat filtration membrane is initially prepared following the non-solvent induced phase separation (NIPS) process by casting polymeric solution onto a supporting material and then submerged in a coagulation bath to initiate phase separation. The coagulation bath may contain water, isopropyl alcohol (IPA), ethanol, methanol, acetone, glycerol, aqueous salt solutions (e.g., NaCl, CaCl₂), etc.), polar aprotic solvents, or other alcohols, individually or in combination. Additionally, in combination, any desired ratio may be used to adjust the phase separation and achieve specific membrane morphologies. For example, as discussed below, the coagulation bath may contain IPA and water.

Porous feed spacer patterns (e.g., square, ladder, diamond, zigzag, etc.) are directly 3D-printed onto a surface of the membrane using a 3D printer. In various embodiments, the 3D printer is equipped with a syringe for dispensing a polymeric material. The polymeric material used for the feed spacer patterns can be the same as the polymeric material used to fabricate the flat membrane. This process is carried out while the membrane is immersed in the coagulation bath, which delays the phase separation and enhances the interconnectivity between the porous feed spacer patterns and the membrane surface. Various concentrations of the polymer solution ranging from 18 wt. % to 28 wt. % in the 3D printing solution were employed to investigate the influence of solution viscosity on both the porous feed spacer patterns' fidelity and the overall performance of the IM. Although a range of 18 wt. % to 28 wt. % was used in the fabrications as discussed herein, concentration ranges may differ depending on a polymer used and a molecular weight of the polymer. The method can further include immersing the IM, after 3D printing of the feed spacer patterns, into at least one of a second coagulation bath or a third coagulation bath to complete the phase separation process, ensuring proper formation of the membrane structure.

Further, incorporated by reference herein is Ibrahim, Y., Hilal, N. Enhancing ultrafiltration membrane permeability and antifouling performance through surface patterning with features resembling feed spacers. npj Clean Water 6, 60 (2023).

For the first time, feed spacers are integrated directly onto the membrane surfaces using 3D printing, eliminating the need for separate plastic and non-porous feed spacer components and simplifying membrane assembly.

Unlike non-porous spacers, the integrated feed spacers are both porous and permeable, enhancing water flow dynamics and filtration efficiency. Additionally, when compared to non-porous spacers, integrated porous spacers increase the membrane effective area which allows for more water flow and eliminate the need for a separate unit (i.e., non-porous feed spacer) in the membrane filtration system.

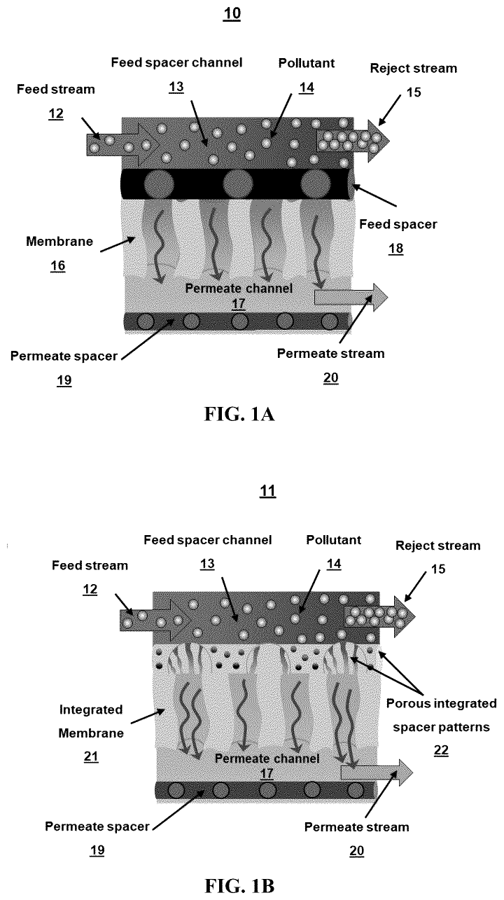

FIG. 1A depicts a first membrane filtration system 10. The first membrane filtration system 10 includes a non-porous feed spacer 18 placed in a feed spacer channel 13 where a feed stream 12 flows parallel to a membrane 16. The first membrane filtration system 10 also includes a permeate channel 17 which includes a permeate spacer 19 and fluid that passed through the membrane 16 from the feed spacer channel 13 to form a permeate stream 20. The feed stream 12 often includes pollutants and undesired particles/ions/molecules 14. Such pollutants 14 are removed from the feed stream 12 using the membrane under pressure-driven or heat-driven factors. Pollutants 14 that do not pass through the membrane 16 remain in the feed spacer channel 13 and form a reject stream 15 that exits the system on the other side.

FIG. 1B depicts a second membrane filtration system, referenced as an IM system 11, herein. The IM system 11 includes an integrated membrane 21 where integrated feed spacer patterns 22 are shown. In various embodiments, the feed space patterns 22 are porous and/or permeable. The IM system 11, according to some embodiments, includes the feed spacer channel 13 where the feed stream 12 flows parallel to the IM membrane 21. The IM system 11 also includes the permeate channel 17 which includes the permeate spacer 19 and fluid that passed through the IM membrane 21 from the feed spacer channel 13 to form the permeate stream 20, as described herein with reference to the first membrane filtration system 10. The feed stream 12 often contains pollutants and undesired particles/ions/molecules 14. Such pollutants 14 are removed from the feed stream using the IM membrane 21 under pressure-driven or heat-driven factors. Pollutants 14 that do not pass through the integrated membrane 21 remain the feed spacer channel 13 and form the reject stream 15 that exits the system on the other side.

The feed spacer pattern 22 may, in some embodiments, be square-shaped patterns, diamond-shaped patterns, ladder-shaped patterns, honeycomb-shaped patterns, or any other geometrical design that is formed by changing a hydrodynamic angle, a flow attack angle, or a pattern dimensions. For example, the hydrodynamic angle in non-porous feed spacers can be an angle formed between two filaments, which faces a feed channel axis. In IM, the hydrodynamic angle can be an angle formed between the feed spacer patterns.

One innovative feature of the IM is the significantly improved anti-fouling performance, stemming from the unique design of the integrated feed spacer patterns on the membrane surface. These patterns generate high shear stress at their peaks, effectively dislodging and removing foulants, thereby keeping these feed spacer patterns clean for optimal water filtration. They also enhance turbulence, effectively mitigating fouling and extending membrane life. This mechanism directly combats common fouling issues, prolonging the membrane's operational life and reducing maintenance needs. The innovation not only ensures sustained high filtration efficiency but also lowers operational costs.

The adoption of 3D printing technology revolutionizes membrane system design by enabling customization of feed spacer geometries and material selection. This capability allows for the creation of optimized flow patterns and improved fouling resistance tailored to specific water treatment needs. Beyond the initial use of square-shaped patterns and PES polymer, the fabrication method facilitates exploring diverse geometries like zigzags, diamond, honeycomb and employing various polymers such as polyvinylidene fluoride (PVDF), polyamide (PA), polysulfone (PSf), polyvinyl alcohol (PVA), among other polymers that can be used to fabricate filtration membranes. This adaptability enhances membrane functionality across different applications, from desalination to wastewater treatment, offering solutions for unique environmental and industrial challenges. Overall, this innovation addresses key challenges in membrane filtration technology by offering a solution that enhances performance, extends lifespan, reduces manufacturing complexity, and opens up new possibilities for customization and optimization in water treatment processes.

The innovation of integrating porous and permeable feed spacer patterns directly onto membrane surfaces via direct 3D printing addresses several critical problems in the realm of membrane filtration technology, particularly in water treatment applications. Below are more details on these critical problems.

Membrane fouling is a pervasive issue that significantly reduces the efficiency and lifespan of filtration systems. Traditional flat membranes and those with non-integrated feed spacers often suffer from rapid fouling, necessitating frequent cleaning or replacement. Moreover, numerous studies have highlighted that the use of plastic and non-porous feed spacers within membrane modules frequently results in zones prone to significant fouling, subsequently causing a decline in membrane performance. It is essential to underscore the pivotal role of feed spacers as integral elements of membrane modules, particularly in spiral wound membrane (SWM) module. These spacers are indispensable for maintaining separation between individual membrane sheets, thereby ensuring optimal functionality the filtration process.

Many membrane technologies encounter significant limitations in achieving optimal water flux, a challenge that is largely attributable to suboptimal water flow dynamics. These inefficiencies stem from the use of plastic and non-porous feed spacers, which disrupt the uniform flow of water across the membrane surface, as well as inherent design limitations within the membrane structure itself. The presence of these spacers often results in stagnant zones and flow dead spots, leading to reduced filtration efficiency and increased susceptibility to fouling.

The IM significantly surpass traditional flat membranes and those equipped with non-integrated and non-porous plastic feed spacers in terms of water flux rates. This superior performance is attributable to the innovative design of porous and permeable integrated feed spacers, which not only enhance the membrane's effective surface area for water filtration but also eliminate the drawbacks associated with common plastic and non-porous spacers. Unlike these conventional spacers, which obstruct part of the membrane's active area, thereby impeding water flow and reducing filtration efficiency, the integrated feed spacers patterns are meticulously designed to augment the available surface area for filtration. This design innovation ensures that larger amounts of water can flow more efficiently through the membrane, leading to significantly improved water flux rates and optimizing the membrane's overall filtration capacity.

The fabrication of traditional membrane modules (i.e., SWM modules) presents a complex and financially burdensome process. This complexity is compounded by the logistical challenges associated with manufacturing feed spacers and membranes in disparate locations, necessitating additional steps to bring these components together. The assembly of these essential parts frequently occurs in a third, different location, introducing further logistical hurdles. Such a fragmented production and assembly process not only escalates costs but also imposes significant constraints on scalability and stifles the potential for innovation within the industry.

The application of direct 3D printing technology for the fabrication of feed spacers directly onto membrane surfaces streamlines the entire manufacturing process, reducing costs and greatly enhancing the scalability of membrane production. This innovative approach eliminates multiple stages traditionally involved in membrane assembly, thereby simplifying logistics and minimizing labor and material expenses. By integrating the feed spacer fabrication directly with membrane production, this method not only ensures a more cohesive product but also opens up new possibilities for customizing membrane designs to specific filtration needs. As a result, this advanced manufacturing technique represents a leap forward in efficiency and flexibility, setting a new standard for the rapid development and deployment of high-performance membrane systems. This application can be applied in a variety of fields for electrical conductivity. For example, feed spacers can be integrated with polymers with conductive properties for enhancing filtration performance and improving flow of reactants. Additionally, this application can be used for enhancing microfiltration, nanofiltration, membrane distillation, forward osmosis, and reverse osmosis performances, among others.

### Preparation of the Integrated Membrane

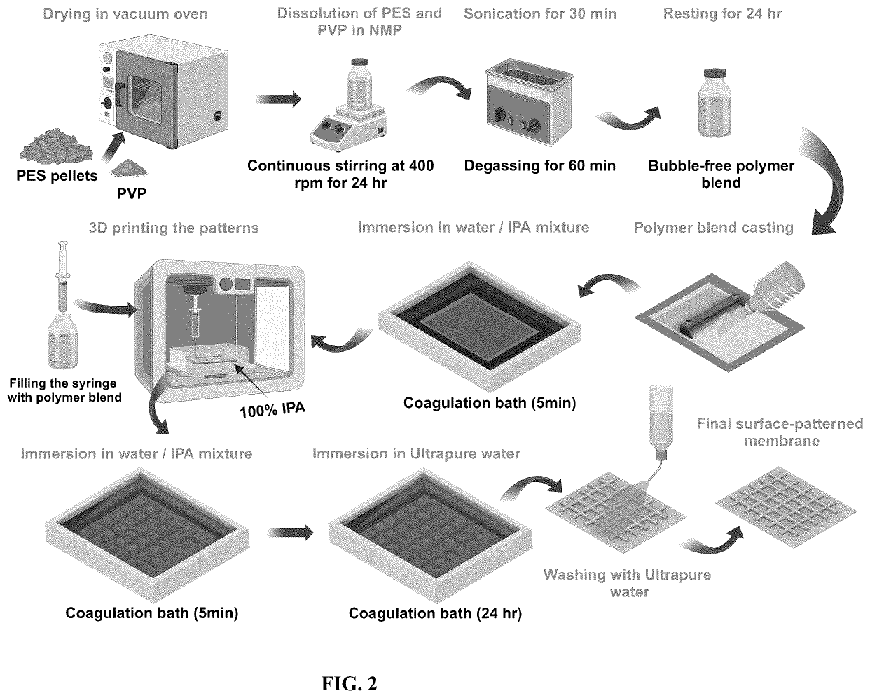

The preparation of the IM is schematically illustrated in FIG. 2. A computer aided design (CAD) of a square-shaped feed spacer shape was prepared using appropriate software. The feed spacer configuration was divided into two layers as shown in FIG. 12 to facilitate a more straightforward 3D printing process. A diameter of the feed spacer pattern was 1.10 millimeter (mm) in both layers. Although the diameter used was 1.10 mm, a range of diameters may be used dependent on an application of the IM. A polymer solution for the membrane was prepared by dissolving 18.0 wt. % PES and 2.00 wt. % polyvinylpyrrolidone (PVP) in 80.0 wt. % N-methyl-2-pyrrolidone (NMP) solvent at room temperature under continuous stirring using a magnetic stirrer for a preset time. In various embodiments, the preset time is approximately 24 hours to ensure a uniform polymer solution.

The 3D printing solution may be prepared with a different or same ratio of PES, PVP, and NMP. In various embodiments, the wt. % of PVP remains the same value and the wt. % of the polymer solution (e.g., PES) and NMP is varied. For example, for an integrated membrane with an integrated porous feed spacer patterns made with 18.0 wt. % polymer solution (P18), the 3D printing solution has 18.0 wt. % PES, 2.0 wt. % PVP, and 80.0% NMP. In another example, for an integrated porous feed spacer pattern made with 25.0 wt. % polymer solution (P25), the 3D printing solution has 25.0 wt. % PES, 2.0 wt. % PVP, and 73.0 wt. % NMP. As depicted in Table 1, feed spacer patterns were 3D printed using polymer blend with PES concentration ranging from 18 wt. % to 28 wt. %. The PVP remained constant at 2.0 wt. % and the NMP was adjusted such that the total wt. % of the PES, PVP, and NMP was 100. In various embodiments, the PVP may be adjusted. Although PES was used in this experiment, as described herein, various polymers (e.g., PVDF, PSf, etc.) may be used for the membrane polymer solution and the 3D printing solution. The air bubbles in these mixtures were removed by the process of ultrasonication for a duration of 30 minutes, followed by degassing for 60 min. Subsequently, the mixtures were allowed to settle for a period of 24 hours before being used in the 3D printing and membrane fabrication process.

TABLE 1
PES, PVP, and NMP concentrations in the polymer blends used
to 3D-print feed spacer patterns and fabricate the membranes.

| Membrane | Feed Spacer | PES | PVP | NMP |
|---|---|---|---|---|
| Code | Pattern Shape | (wt %) | (wt %) | (wt %) |
| F18 | none | 18 | 2 | 80 |
| FS18^{a} | none | 18 | 2 | 80 |
| P18^{b} | square | 18 | 2 | 80 |
| P20^{b} | square | 20 | 2 | 78 |
| P22^{b} | square | 22 | 2 | 76 |
| P25^{b} | square | 25 | 2 | 73 |
| P28^{b} | square | 28 | 2 | 70 |

^{a}Flat PES membrane with nonporous PLA feed spacer.
^{b}The numerical value represents the polymer concentration in the 3D printing solution utilized for porous PES feed spacer patterns creation.

### Fabrication of the Integrated Membrane

The membrane polymer solution was casted onto an NMP-wetted membrane support fixed on a glass plate with a casting knife, maintaining a fixed gap height. In various embodiments, the fixed gap heigh is 200 μm. The glass plate was immersed in a coagulation bath containing a water/IPA mixture (e.g., with a volume ratio of 25:75) for 5 minutes to facilitate membrane formation. An accessory of the 3D printer was filled with the 3D printing solution. The accessory may be a dispensing syringe. The CAD can be transformed into stereolithography format (STL) and further processed to produce the appropriate G-code to be interpreted by the 3D printer. Additionally, the casted membrane was immersed in a pure IPA solution and the feed spacer patterns were directly 3D printed using a desktop 3D printer. The printing speed was set to be 2.00 mm/s and a 5 mL syringe dispensing head with a blunt needle that had an internal diameter of 0.41 mm were used in the process. Both the printing speed of 2.00 mm/s and the blunt needle diameter of 0.41 mm were carefully selected after an optimization process, which involved testing various printing speeds and blunt needle sizes with an internal diameter ranging from 0.26 to 0.60 mm. These parameters were found to yield the best results in terms of pattern fidelity, reproducibility, and consistency across different polymer concentrations and viscosities.

IPA was used to alter the solvent/nonsolvent exchange kinetics, resulting in a slower demixing rate between the solvent and nonsolvent (i.e., delayed NIPS or membrane formation process) compared to using water alone. This slower process allowed for better control over the morphology development of the membrane as well as the interconnectivity of the feed spacer patterns with the base membrane during the 3D printing process. This resulted in enhanced adhesion and integration of the patterned structures within the membrane matrix.

In various embodiments, the prepared integrated membrane (IM) with integrated porous feed spacer patterns (e.g., after the 3D printing process) is immersed in a second coagulation bath containing ultrapure water/IPA mixture (e.g., with a volume ratio of 25:75) for 5 minutes to stabilize the feed spacer patterns. The IM may then be placed in a water coagulation bath for 24 hours to complete membrane formation where a final IM with integrated porous feed spacer patterns made with a wt. % polymer solution is formed.

### Fabrication of the Unintegrated/Unpatterned Membrane

The preparation of the unintegrated/unpatterned membrane with separate non-porous feed spacer was carried out to serve as a base comparison for the IM. Initially, a computer aided design (CAD) of a square-shaped feed spacer shape with 1.10 mm in filament diameter was prepared using appropriate software. The CAD design was then transformed into stereolithography format (STL) and further processed to produce the appropriate G-code that can be interpreted by the 3D printer. Following this, the non-porous feed spacer was 3D-printed from polylactic acid (PLA) material using fused deposition modeling (FDM) 3D printer.

The membrane polymer solution was then prepared by dissolving 18.0 wt. % PES and 2.00 wt. % PVP in 80.0 wt. % NMP solvent at room temperature under continuous stirring using a magnetic stirrer for 24 hours to ensure a uniform polymer solution. The air bubbles in this mixture were removed by the process of ultrasonication for a duration of 30 minutes, followed by degassing for 60 min. Subsequently, the mixture was allowed to settle for a period of 24 hours before being used in the flat membrane fabrication process.

Following this, the bubble-free polymer solution (18 wt. % PES) was cast onto an NMP-wetted membrane support fixed on a glass plate with a casting knife, maintaining a fixed gap height. In various embodiments, the fixed gap heigh is approximately 200 μm. The glass plate was immediately immersed in a coagulation bath containing a water/IPA mixture (with a volume ratio of 25:75) for 5 minutes to facilitate membrane formation. This was used to form the flat unintegrated/unpatterned membrane, referred to as F18 membrane in Table 1 and herein. F18 when used alongside the non-porous feed spacer in relevant experiments, was referred to as FS18.

### Materials.

The PES used as disclosed herein was obtained from Goodfellow Cambridge Limited, United Kingdom, and had a molecular weight of 58.0 kDa. 1-Methyl-2-pyrrolidone EMPLURA (NMP), polyvinylpyrrolidone (PVP) with a Mw of 40.0 kDa, hydrochloric acid (HCl) (36.0-38.5%), sodium hydroxide (NaOH), humic acid (HA) in technical grade, isopropyl alcohol (IPA) (2-propanol EMSURE with purity ≥99.0%), polyethylene glycol (PEG) with molecular weights of 10.0 and 35.0 kDa, and polyethylene oxide (PEO) with a Mw of 300 kDa were all acquired from Sigma-Aldrich. A 5.25% solution of sodium hypochlorite (NaOCl) was acquired from a nearby source. The membrane support sheet, composed of nonwoven polypropylene/polyethylene (PP/PE) with a thickness of 180.0 μm (Novatexx 2471 as referred to by the supplier), was purchased from Freudenberg-Filter in Germany. Milli-Q 7015 filtration equipment was used to produce pure water for the making of mixtures. All chemicals and materials were used in their original state without any modifications.

1-Methyl-2-pyrrolidone (NMP) was employed as the solvent to dissolve PES and PVP, with PVP acting as a pore-forming agent to enhance membrane porosity and hydrophilicity. IPA and water, with different volume ratios, were used in the coagulation bath to initiate membrane formation using the well-established method, non-solvent-induce phase separation (NIPS). Although NIPS was used in this experiment, it can be appreciated by those skilled in the art that other phase separation and membrane fabrication methods can be used to synthesize the membranes.

### Feed Spacer Design and Geometry.

The feed spacer was designed using Autodesk Fusion360 software, and a square-shaped feed spacer was used in this study due to the prevalent use of such spacer in commercial membrane modules. The feed spacer configuration was divided into two layers, as illustrated in FIG. 12, to facilitate a more straightforward 3D printing process. The filament diameter (“dF”) of the feed spacer was 1.10 mm in both layers. Ultimately, the Autodesk Fusion360 designs were transformed into stercolithography format (“STL”) and further processed using Slic3r software to produce the appropriate G-code that can be interpreted by the 3D printer.

### Rheological Analysis of the 3D Printing Solutions.

The rotational rheometer (MCR72, Anton Paar GmbH, Austria) with a 50 mm diameter parallel-plate measuring system was employed to assess the rheological characteristics of the prepared polymer blends containing varying concentrations of PES. A sufficient quantity of the polymer blend sample was applied onto the stationary plate, and the rotating plate was descended to come into contact with this sample while ensuring a 1 mm gap between the stationary and rotating plates. The viscosity (n; millipascal-second (mPa·s)) was subsequently recorded over a range of shear rates from 1 to 50 s⁻¹ at room temperature. Before initiating the measurement, the sample was exposed to a short preshearing stage at elevated shear rates to enhance the conditioning of the sample. Each test was repeated three times, and average values were reported.

### 3D Printing Accuracy and Area Fidelity.

To evaluate the precision and fidelity of the 3D printing process, a range of polymer concentrations was employed in the 3D printing solution, as shown earlier in Table 1. This approach allowed for a comprehensive evaluation of how different concentrations of PES polymer affect the accuracy and fidelity of the printed porous patterns. A high-accuracy 3D scanner (EinScan-SP V2, SHINING 3D, China) with a resolution better than 0.05 mm was employed to capture the 3D geometry of the fabricated integrated membranes. High dynamic range (“HDR”) mode was enabled during the scanning to enhance the scanning power and improve contrast. A turntable speed of 6 was used in the process and a total of 16 turntable steps were employed to create the 3D geometry with high accuracy. Using the EinScan 3D Scanning software, which accompanies the 3D scanner, the surface area of the integrated membranes was determined. The software enables a straightforward selection of the 3D-scanned object for analysis and incorporates a built-in function for measuring surface area. In total, 3 membrane samples of each type were 3D-scanned and average surface area values were reported. The surface area calculated from the 3D-scanned membranes served as the basis for assessing the precision of the 3D printing process, and evaluating the fidelity of the print using Eq. 1:

$$area fidelity ( \% ) = ( \frac{S {A}_{3 DScanned} - S {A}_{TheoFlat}}{S {A}_{TheoPattern}} ) \times 100 \qquad ( 1 )$$

where SA_{3DScanned} represents the surface area obtained from the 3D-scanned membrane in mm², SA_{TheoFlat} is the theoretical surface area of the interspace between the patterns as calculated from Autodesk Fusion360 software in mm², and SA_{TheoPattern} is the theoretical surface area of the patterns as calculated from Autodesk Fusion360 software in mm². Considering the pattern surface area provides a more precise representation of 3D printing accuracy compared to solely considering the length or width of the pattern.

### Integrated and Unintegrated Membranes Characterization.

Thermo Fisher Quanta 450 FEG scanning electron microscope (“SEM”) was used to analyze the morphological changes in the membranes as well as the integrated PES feed spacer patterns. For the preparation of membrane samples for cross-sectional investigations, the freeze-fracture technique with liquid nitrogen was employed. Furthermore, to enhance the resolution of the SEM images, a very small coating of gold was applied to the fabricated membranes, as they were naturally nonconductive. Universal Testing System (5965 model, Instron) was employed to evaluate the mechanical properties of the fabricated membranes. Samples 65.0 mm in length and 10.0 mm in width were cut and loaded into the mechanical testing machine. To ensure that only the middle section measuring 20.0 mm in length and 5.00 mm in width was subjected to the load, the samples were fastened using the testing machine's built-in rough grips and a 0.50 mm min⁻¹ cross-head velocity was applied to all samples. Elongation at break (“EAB”; %) was then calculated using Eq. 2:

$$EAB ( \% ) = \frac{displacement at sample full break ( mm )}{initial sample length ( mm )} \times 100 \qquad ( 2 )$$

The hydrophilicity [i.e., water contact angle (“WCA”)] of the fabricated membranes was assessed using DSA 100 S, Krüss Scientific drop shape analyzer. The water droplet size used in all measurements was ≈5.00 μL and the WCA values were obtained at various locations of the membrane sample. The surface free energy (−ΔG_{SL}) was then determined using the Young-Dupre equation that utilizes the WCA (θ) and surface tension of water (Y_{L}) (Eq. 3):

$$- Δ {G}_{S L} = ( 1 + cos θ ) \times {γ}_{L} \qquad ( 3 )$$

Thermogravimetric analysis (“TGA”), using the NETZSCH TG 209 Tarsus machine, was used to assess the thermal decomposition of the fabricated membranes in the 30.0-750° C. temperature range. A protective nitrogen flow of 20.0 mL min⁻¹ and 15.0° C. min⁻¹ heat rate was applied in all measurements and the decomposition temperature (Ta) was then determined at 15.0% weight loss.

The surface porosity (ε; %) for both the flat surface on the integrated membranes and the surface of the PES feed spacer patterns was determined using ImageJ (NIH) software and the captured SEM images. All measurements were carried out in triplicate, and average values were reported. Analysis of variance (“ANOVA”) test, performed at a 95% confidence level, was applied to the obtained porosity and WCA results. The solute separation method was used to assess the average effective pore size (Up) and distribution of pore sizes in all membranes. In short, solutions containing PEG (10.0 or 35.0 kDa) or PEO (300 kDa) were filtered using the fabricated membranes. Solute rejection (R; %) was subsequently calculated using Eq. 4, with the concentrations of solutes in both the feed (CF; mg L⁻¹) and permeate (Cp; mg L⁻¹) measured using the total organic carbon (“TOC”) analyzer machine.

$$R ( \% ) = ( \frac{{C}_{F} - {C}_{P}}{{C}_{F}} ) \times 100 \qquad ( 4 )$$

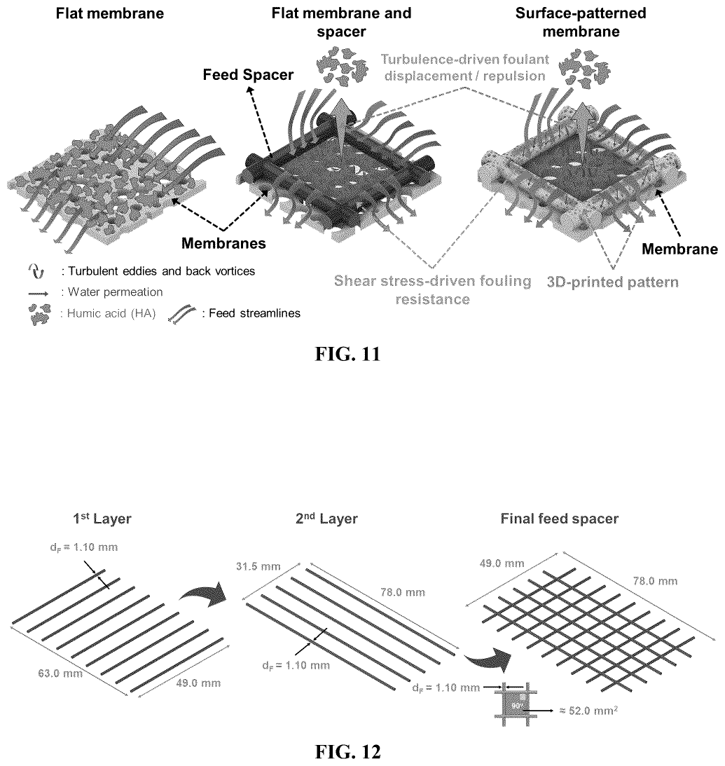

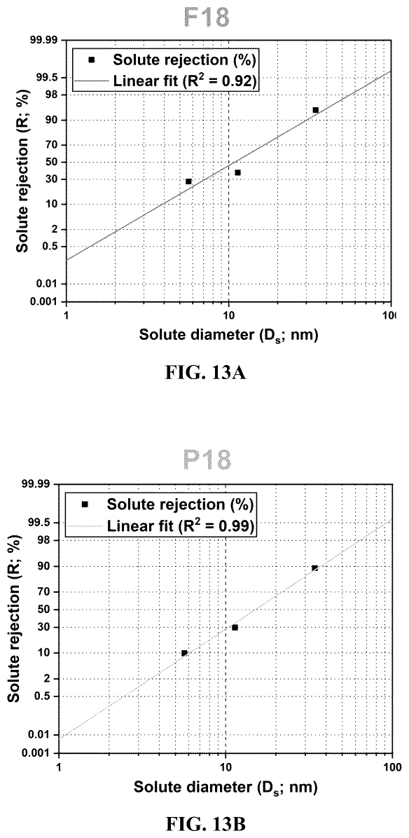

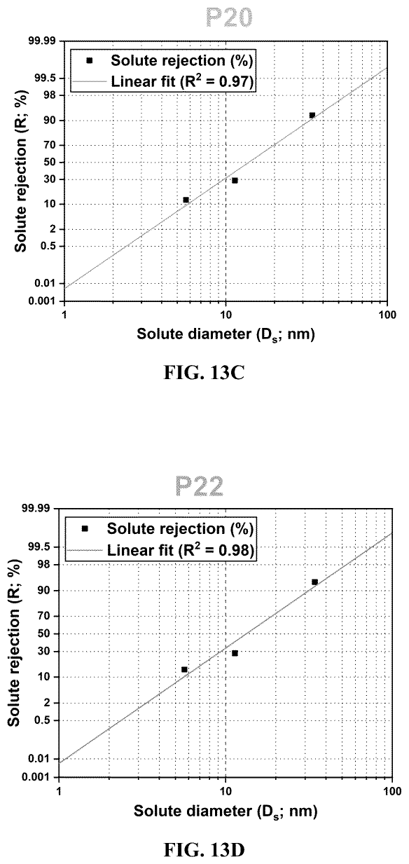

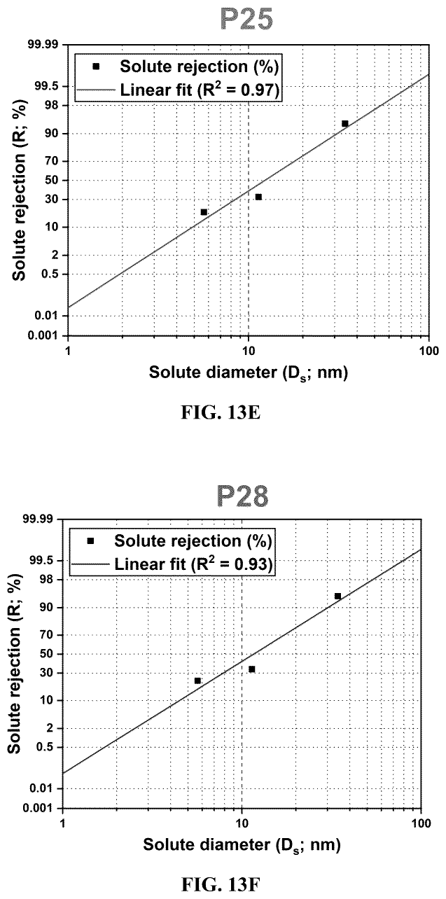

when R versus Stokes diameter (D_{S}; nm) is plotted on a log-normal probability paper and fitted on a straight line, μP can be determined at R=50% and the geometric standard deviation (Op) can be determined as the ratio of D_{S} at R=84.13% over D_{S} at R=50% (FIGS. 13A-13F). Additional information on this methodology and the equations used to calculate D_{S} and the pore size distribution can be found elsewhere in the literature.

### Membrane Fouling Using HA and Water Flux Tests.

All membranes were tested for pure water flux (J_{w}) using the Convergence Inspector (UF Hydra) crossflow automated system which is equipped with several pumps, flow control valves, pressure sensors, and a testing cell with a membrane-active area of 79.0×50.0 mm². A 2.00 bar transmembrane pressure (“TMP”) and 7.00 Lh⁻¹ feed flow rate of clean water were used in the compaction of all membranes. J_{w} was then determined at 1.00 bar using Eq. 5, at the end of the compaction procedure.

$${J}_{w} = ( \frac{{V}_{w}}{{A}_{m} \times Δ t} ) \qquad ( 5 )$$

where V_{w} is the permeate volume (“L”), At is the time of filtration (h), and Aₘ is the flat membrane area (m²). The permeate fluxes in all membranes (i.e., flat and surface-patterned) were calculated based on the flat area of the membrane.

Various membrane samples, fabricated on different days, were employed to measure pure water flux, with the reported results representing averages. The fouling tests were conducted with a 25.0 mg L⁻¹ humic acid (“HA”) solution for 4.00 h using the same crossflow system under a TMP of 1.00 bar. The decline in flux was continuously observed throughout the experiment, and the relative flux was calculated using Eq. 6:

$$relative flux = ( \frac{{J}_{2}}{{J}_{1}} ) \qquad ( 6 )$$

Here J₂ denotes the fluctuating flux observed during the HA fouling experiment in L m⁻² h⁻¹ and J₁ represents the flux at the start of the experiment in L m⁻² h⁻¹.

The HA solution was prepared following a well-described procedure in the literature. Briefly, a 1000 mg L⁻¹ stock solution of HA was prepared by dissolving 1000 mg of HA in 100 mL of 0.10 M NaOH solution and subsequently adding 900 mL of ultrapure water with continuous stirring. 5.00 M HCl was then used to modify the pH of the solution to 7.00. This solution was stirred adequately at room temperature and subsequently filtered using VWR quantitative filter paper (Grade 434). Lastly, solutions of HA were prepared with specified concentrations (0.50, 1.00, 5.00, 10.0, and 25.0 mg L⁻¹) by diluting the stock solution with ultrapure water. These solutions were utilized to obtain the calibration curve of HA using a UV-vis spectrophotometer (UV-3100PC, VWR) at a wavelength of 254 nm. The rejection of the membranes to HA was determined during the fouling experiment by measuring the concentration of HA in the feed and permeate using a UV-vis spectrophotometer at 254 nm. The removal efficiency was then determined using Eq. 7:

$$HA rejection ( R ; \% ) = ( \frac{{C}_{H A F} - {C}_{H A P}}{{C}_{H A F}} ) \times 100 \qquad ( 7 )$$

where C_{HAF} is the concentration of HA in the feed solution (mg L⁻¹), and CHAP is the concentration of HA in the permeate (mg L⁻¹).

The membranes cleaning producer involved rinsing with clean water followed by immersion in 2000 mg L⁻¹ sodium hypochlorite solution (pH=11.0) for 1 h. Subsequently, ultrapure water was used to wash the membrane multiple times to be re-retested for ultrapure water flux. The flux recovery ratio (FRR; %) was then determined as the ratio between the water flux of the cleaned membrane after HA solution filtration (J_{w1}) and the clean water flux of the virgin membrane (J_{w0}) as per Eq. 8:

$$FRR ( \% ) = ( \frac{{J}_{w 1}}{{J}_{w 0}} ) \times 100 \qquad ( 8 )$$

### Pressure Drops in the Feed Channel.

A laboratory-scale system was used to evaluate the pressure drop as described in detail in our previous work. In short, flat, integrated membranes with porous PES feed spacer or flat membrane with 3D-printed PLA feed spacer were loaded into the feed side of the filtration cell. Following that, a flat, porous plate was positioned on the permeate side of the cell to prevent the bending of the membranes. A crossflow velocity ranging from 0.45 to 1.47 m s⁻¹ was employed to assess the pressure drop across the feed channel, encompassing a broad spectrum of operated membrane systems. The pressure across the feed channel was recorded using digital pressure gauges with 0.001 bar resolution and used in determining the pressure drop. The increase/decrease in pressure drop with respect to the pressure drop observed in the feed channel with FS18 membrane was determined using Eq. 9:

$$pressure drop increase / decrease ( \% ) = ( \frac{{P}_{E} - {P}_{j}}{{P}_{E}} ) \times 100 \qquad ( 9 )$$

where P_{E} is the registered pressure in the feed channel when using the FS18 membrane (mbar) and Pⱼ is the registered pressure in the feed channel when using the integrated membranes (P18-P28) (mbar). Both P_{E} and Pⱼ were calculated by determining the difference between the registered pressure at the inlet of the filtration cell (i.e., feed side) and the registered pressure at the outlet of the filtration cell (i.e., retentate side). A positive value of the pressure drop increase/decrease (%) indicates a lower pressure drop in the membranes with an integrated feed spacer (i.e., pressure drop decrease), while a negative value signifies a higher pressure drop (i.e., pressure drop increase).

### Results and Discussion.

### 3D Printing Accuracy and Rheological Behavior.

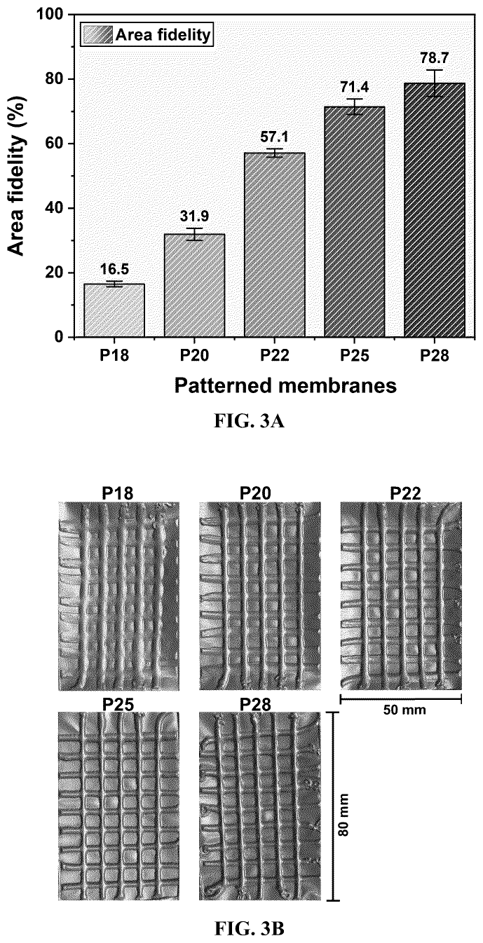

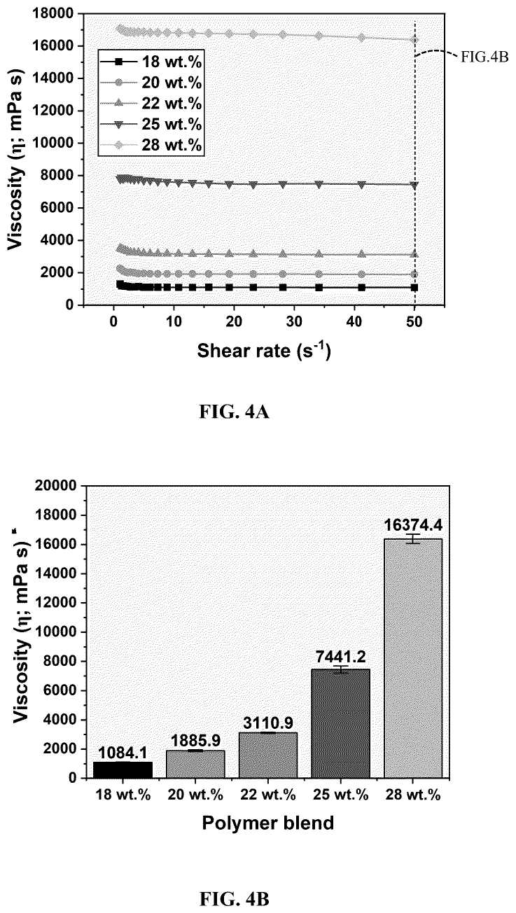

Five polymeric solutions were prepared to explore the influence of different concentrations of PES within the 3D printing solution on the precision and fidelity of the feed spacer patterns in the integrated membranes. The results in FIG. 3A showed that the area fidelity of patterns increases with an increase in the PES concentration in the 3D printing solution. For instance, the area fidelity of the patterns increased from 16.5+0.89% in the P18 membrane to as high as 78.7+4.10% in the P28 membrane. The feed spacer patterns within the P18 membrane appear nearly flat, making it challenging to distinguish them from the membrane surface. Conversely, increasing the concentration of PES in the 3D printing solution notably enhanced the definition of the patterns, as visually demonstrated in the 3D-scanned membranes shown in FIG. 3B. This phenomenon can be attributed to the augmented viscosity of the 3D printing solution with the rise in PES content, as illustrated in FIGS. 4A-4B. At lower viscosities, there is a propensity for excessive material flow during printing, leading to a tendency for the patterns to flatten. Furthermore, using water/IPA mixture as the coagulant during the NIPS process slows down the coagulation process (i.e., membrane and pattern formation) due to the presence of IPA in the solution. This slower coagulation process can lead to less defined patterns on the membrane surface. Nonetheless, a slower coagulation process is essential to ensure better interconnectivity between the 3D-printed patterns and the membrane surface.

Elevating the viscosity of the solution serves to heighten the resistance to spreading or flattening when extruded through the nozzle owing to the increased resistance to deformation. Materials characterized by higher viscosities exhibit a thicker and more cohesive nature. Therefore, a higher-viscosity polymer blend solution can maintain structural integrity during the printing process and provide better adhesion and interaction of the 3D-printed layer with the base membrane, resulting in clearer and more defined patterns. This behavior is commonly reported in the existing literature. It is noteworthy that utilizing a polymer blend solution with concentrations exceeding 28 wt. % resulted in severely compromised printability, often manifesting in nozzle jams and complete unprintability. This issue is primarily attributed to the substantially increased viscosity of such solutions. On the other hand, A lower concentration of PES in the 3D printing solution (i.e., lower than 18 wt. %) resulted in significant flattening of patterns and loss of fidelity during the printing process. Consequently, it was determined that, under the specified study conditions, the upper and lower limits for the polymer concentration conducive to successfully 3D printing PES feed spacer onto a PES membrane were 28 wt. % and 18 wt. %, respectively.

### Analysis of the Fabricated Membranes Via SEM.

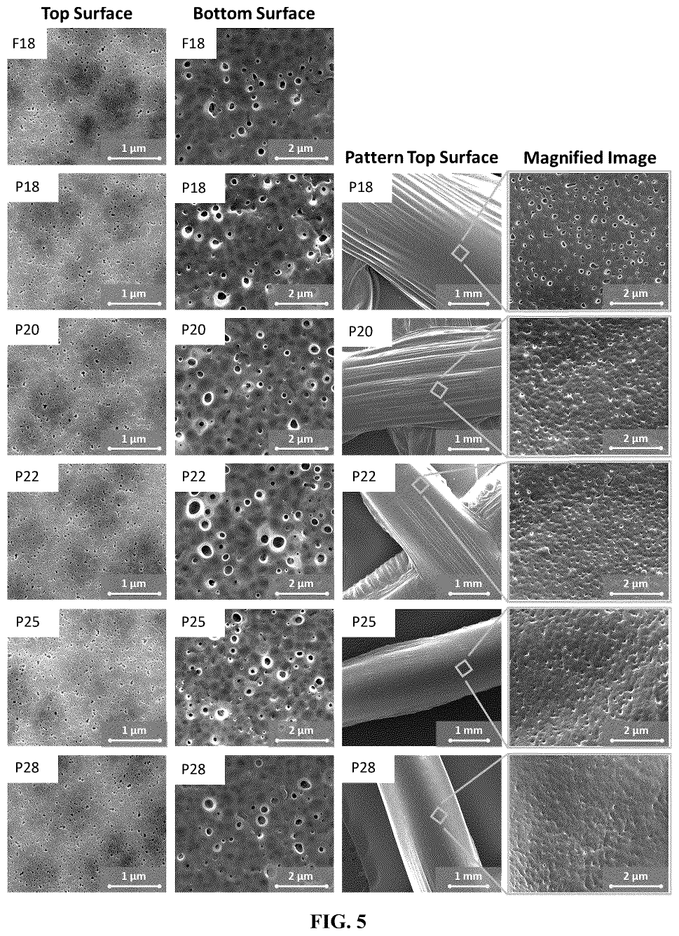

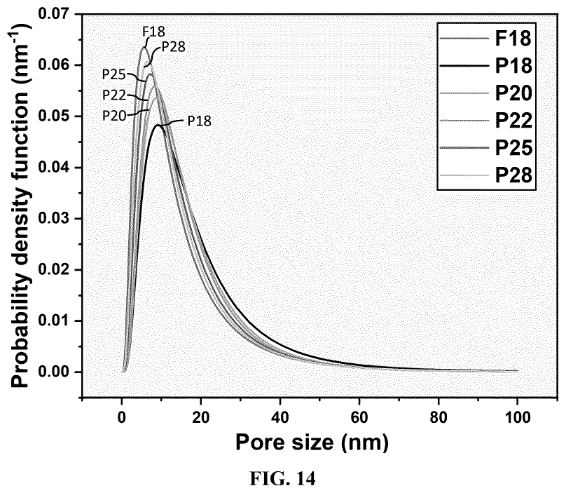

SEM was used to analyze the surface properties of the membranes from several perspectives, including the cross-sectional, bottom, as well as top surfaces. A distinctive membrane structure can be observed in all membranes with a dense upper surface containing holes of nanoscale, and a bottom surface with higher porosity and noticeably bigger pores (FIG. 5). As evident from the SEM images, there is no visible difference in the surface properties of the membranes between the F18 membrane and all other integrated membranes. This lack of disparity is primarily related to the fact that these images were taken in the interspace between the patterns. Furthermore, the base membrane of all integrated membranes was fabricated from a polymer blend solution containing 18 wt. % PES, as discussed earlier. On the other hand, the patterns with varying concentrations of PES in the 3D printing solution showed significantly different surface morphology. Although being less porous, the patterns generally exhibit larger pores than the flat F18 membrane. Throughout the 3D printing process, the deposited patterns tend to undergo slight spreading or flattening, contingent upon the viscosity of the solution. Simultaneously, as the pores commence formation, they tend to distort, contributing to an eventual increase in the pore size. Moreover, during the 3D printing of patterns, the solution slightly penetrates the base membrane, exerting a gentle force that displaces the membrane from the glass substrate. This promotes the onset of the phase separation process from the bottom side, thereby enhancing the demixing rate and potentially leading to the formation of larger pores. Nonetheless, as evident in the magnified images of the patterns (FIG. 5), there is a noticeable reduction in porosity and pore size distribution (FIG. 14) as the polymer concentration increases from 18 wt. % in the P18 membrane to 28 wt. % in the P28 membrane. This phenomenon is primarily associated with the decelerated demixing rate occurring with an elevated polymer concentration in the 3D printing solution. The viscosity of membrane casting solutions is recognized to be a crucial factor influencing the demixing rate of NMP with the nonsolvent during the NIPS process. The hindering effect on the diffusion rate between the solvent (i.e., NMP) and nonsolvent (IPA or water) is a direct consequence of increased viscosity. With an increase in the polymer content within the solution, there is a corresponding increase in the polymer present at the membrane-nonsolvent interface. This surge impedes the solvent-nonsolvent exchange rate, leading to a considerable delay in the demixing process. This delay, in turn, suppresses porosity and diminishes pore size on the surface of the patterns, as reported in several studies.

Another contributing factor to the delayed demixing is the presence of IPA in the coagulation bath during the 3D printing process, characterized by its lower solubility with NMP. In fact, when alcohols are employed as non-solvents, the binodal region in the ternary phase diagram experiences a notable reduction in size. This implies that a larger quantity of alcohol is required to diffuse into the polymer solution before reaching the binodal region, where phase separation takes place. Nonetheless, this phenomenon proves advantageous in our case, as it facilitates enhanced interconnectivity between the patterns and the base membrane during the 3D printing process.

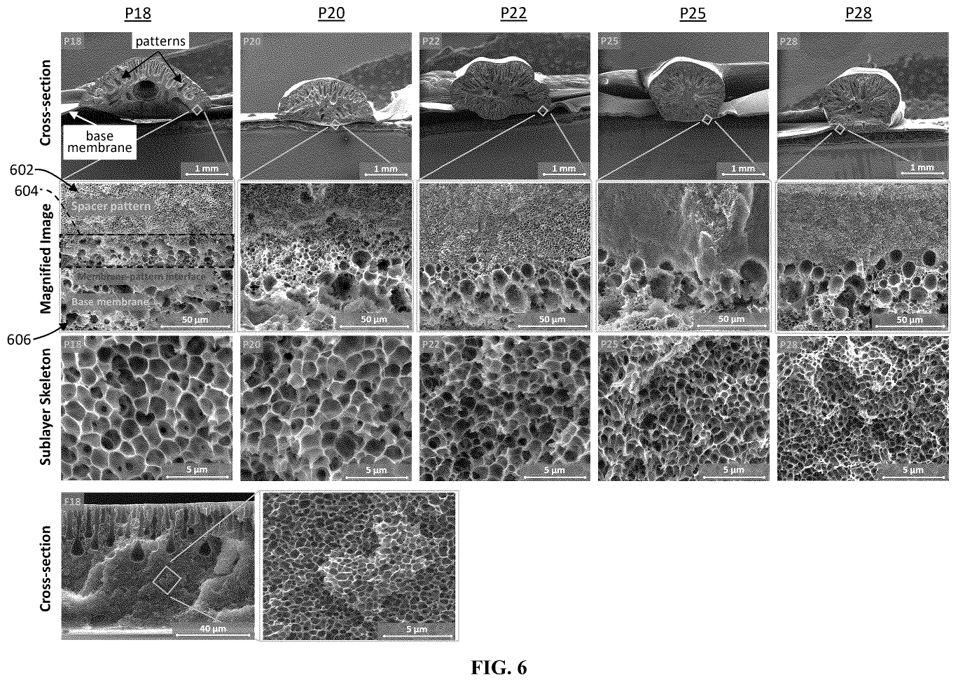

The asymmetric structure of the membranes is evident from the cross-sectional SEM images shown in FIG. 6. All membranes exhibit thin dense skin layer with nanopores and porous supporting layer along with non-fully developed finger-like macrovoids. As mentioned earlier, the presence of IPA in the coagulation bath slows down the demixing rate during the NIPS process. This impedes the progression of the finger-like structures emerging from the interface between the polymer solution and the nonsolvent toward the bottom surface. The decelerated demixing rate gives rise to the development of a sponge-like structure within the sublayer skeleton. Moreover, a further reduction in the demixing rate due to the heightened viscosity of the 3D printing solution results in even more diminutive inner apertures in the sublayer skeleton, as conspicuously observed in the P25 and P28 membranes.

The interface, referenced as membrane-pattern interface 604, between a spacer pattern 602 and a base membrane 606 can be clearly seen from the magnified images in FIG. 6. This interface 604 exhibits a sponge-like structure with very good interconnectivity, which facilitates the passage of water molecules through the membrane. The observed interconnectivity between the 3D-printed patterns (e.g., the space pattern 602) and the base membrane 606 was facilitated by the slower coagulation rate during the NIPS process, which was achieved through the use of IPA in the coagulation bath. This slower coagulation rate allowed the 3D-printed patterns ample time to penetrate the base membrane before full precipitation occurred, enabling effective integration between the patterns and the base membrane. Lastly, the cross-sectional images of the integrated membranes revealed a discernible enhancement in pattern definition with an increase in polymer concentration in the 3D printing solution. Consequently, this improvement results in improved area fidelity, as shown earlier in FIG. 3A.

### Performance of the Fabricated Membranes.

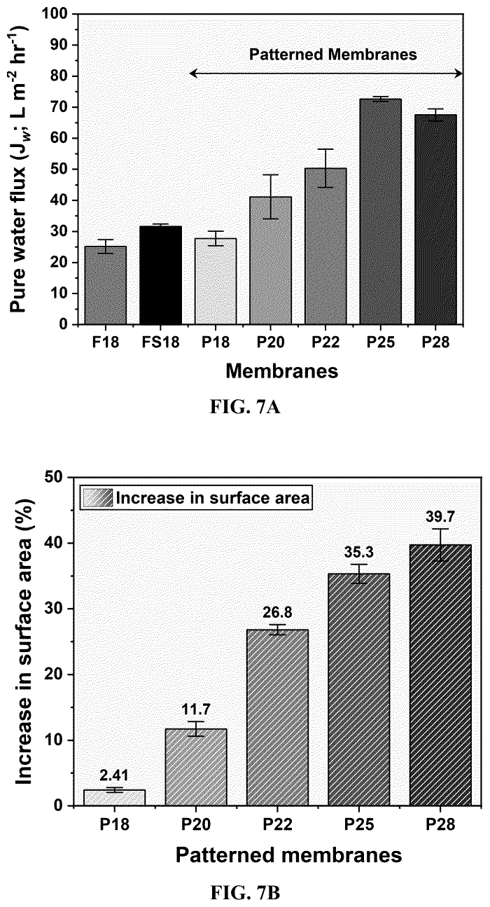

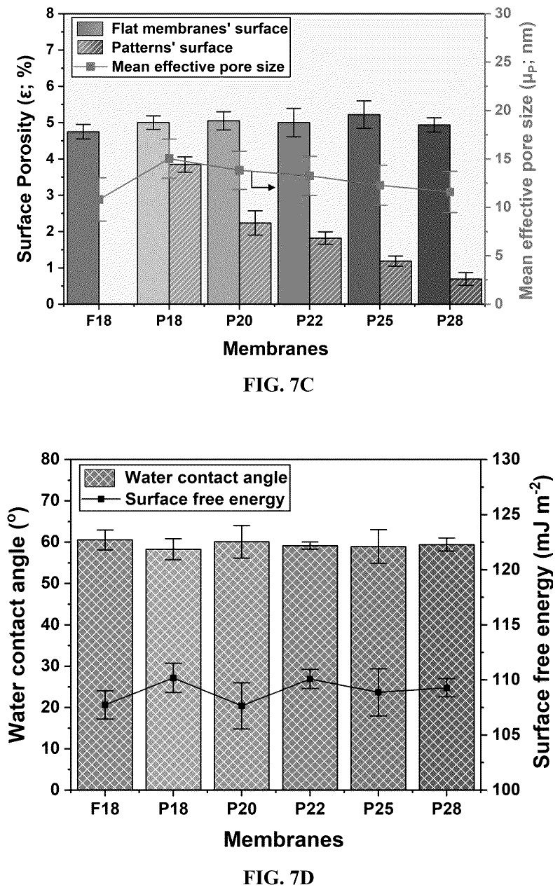

Pure water flux measurement serves as a fundamental metric for evaluating the effectiveness of newly fabricated membranes. Consequently, both flat and integrated membranes with PES feed spacers were evaluated for their ultrapure water flux, and the results are summarized in FIG. 7A. The F18 membrane reported 25.1+2.22 L m⁻² h⁻¹ compared to 31.6+0.78 L m⁻² h⁻¹ in the FS18 membrane that utilizes a 3D-printed PLA feed spacer. This small improvement in pure water flux can be attributed to the increased turbulence in flow and shear stresses near the membrane surface, induced by the presence of the feed spacer. This, in turn, augments the mass transfer across the membrane. The same effect is also present in the integrated membranes; however, the impact of increased effective surface area on the water flux is more pronounced. For instance, the P25 membrane reported a pure water flux of 72.6±0.79 L m⁻² h⁻¹ which is ˜2.90 and 2.30 times larger than those of the F18 and FS18 membranes, respectively. The augmented water flux is correlated with the amplified surface area conducive to water permeation within the integrated membranes, facilitated by the presence of integrated PES feed spacers. In comparison to the effective surface area of the flat PES membrane, the P18, 20, 22, 25, and 28 membranes showcase surface areas that are 2.41±0.38, 11.7±1.13, 26.8±0.78, 35.3±1.44, and 39.7±2.44% larger, respectively (FIG. 7B). The marginal growth in surface area observed in the P18 membrane can be primarily attributed to the flattening of surface patterns during the 3D printing process, a consequence of the low viscosity in the 3D printing solution. As discussed previously, this resulted in diminished area fidelity of the patterns, subsequently leading to a negligible enhancement in the water flux, as shown in FIG. 7A.

Increasing the viscosity of the 3D printing solution further proved advantageous in augmenting the area fidelity and subsequently enhancing the effective surface area and pure water flux. However, it is crucial to note that at elevated viscosities the demixing rate during the NIPS process can be significantly impeded, resulting in less porous surface patterns, as observed in the SEM images earlier. This, in turn, counteracted the improvement in the effective surface of the P28 membrane, leading to a reduction in pure water flux to 67.5±1.94 L m⁻² h⁻¹, compared to 72.6+0.79 L m⁻² h⁻¹ in the P25 membrane. As illustrated in FIG. 7C, the surface porosity (E; %) of the base membrane in both flat and integrated membranes remains indistinguishable. Specifically, the ANOVA test results revealed that the & values, ranging from ˜4.70 to 5.20% for all membranes, exhibited no statistically significant differences. Conversely, the feed spacer patterns on the integrated membranes exhibited statistically distinct & values, with a noticeable reduction from 3.84+0.21% in the P18 membrane to 0.69+0.17% in the P28 membrane (FIG. 7C). This also led to an overall reduction in the mean effective pore size (Up; nm) from 15.02+2.02 nm in the P18 membrane to 11.58+2.13 nm in the P28 membrane. Nonetheless, it is noteworthy that these pore sizes were marginally larger than those of the F18 membrane (10.79+2.23 nm). This discrepancy can be attributed to the spreading (or flattening, in the case of the P18 membrane) of patterns during the 3D printing process, inducing deformations in the membrane pores.

The WCA and surface free energy measurements (−ΔG_{SL}; mJ m⁻²) for all membranes are presented in FIG. 7D. Notably, no discernible difference in WCA was observed between the flat and integrated membranes, as measurements for the latter were taken in the flat interspace between the patterns (i.e., on the base membrane). The inherent nature of the patterns made direct WCA measurements unfeasible. The WCA results ranged from 58.28±2.57° to 60.55±2.42°, with the ANOVA test results indicating no statistically significant differences among the membranes.

### Thermal and Mechanical Stabilities.

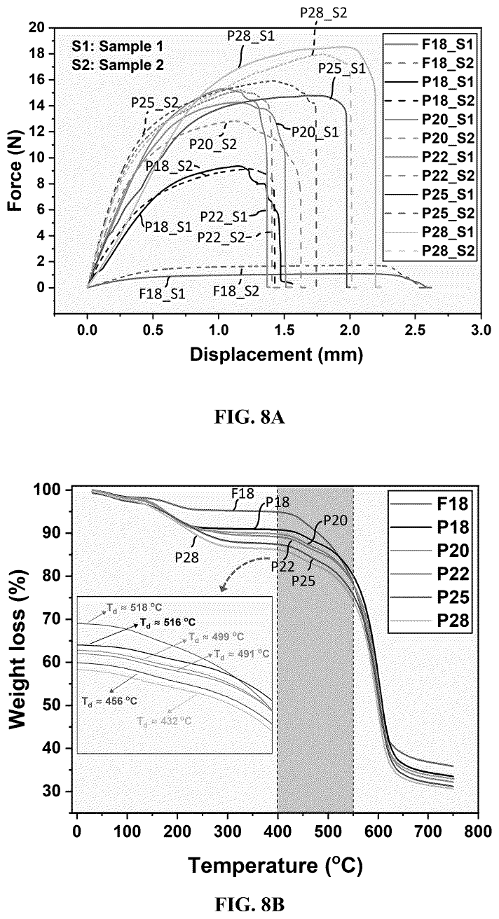

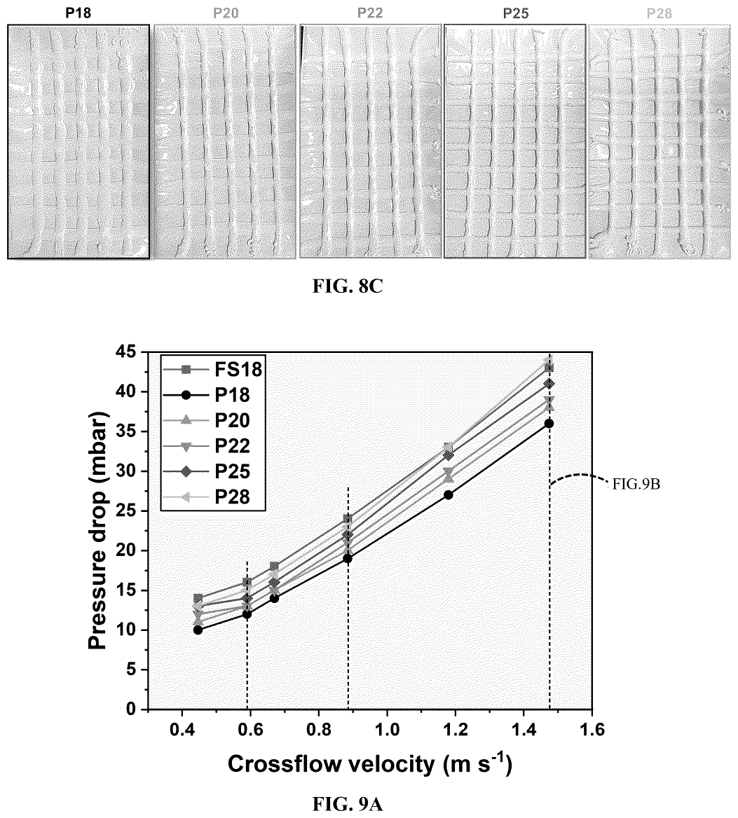

Evaluating the mechanical and thermal properties of membranes is essential for ensuring their reliability and longevity in water treatment applications. The mechanical properties of the integrated membranes with porous PES feed spacers were examined by performing force vs displacement measurements on two samples of each membrane, and the results are summarized in FIG. 8A. The F18 membrane exhibited the highest elongation-at-break (EAB; %), reaching 12.7±0.04%, in comparison to all integrated membranes featuring porous PES feed spacers, as also shown in Table 2. This increased EAB is primarily attributed to the substantial presence of a sponge-like structure in the F18 membrane, as evident in the earlier cross-sectional SEM images. Conversely, within the integrated membranes, the NIPS process commences from both the upper and lower surfaces, encompassing the entire circumference of the feed spacer pattern, leading to the development of a finger-like structure in all directions. Generally, these structures exhibit lower mechanical strength compared to the sponge-like structures. Moreover, with an increase in the viscosity of the 3D printing solution, the demixing rate decelerates, impeding the progression of the finger-like structure and encouraging the development of a sponge-like structure within the sublayer skeleton.

TABLE 2
Summary of the mechanical properties of the membranes.

| Membrane | Elongation at Break | Peak Applied Force |
|---|---|---|
| Code | (%) | (N) |
| F18 | 12.7 ± 0.04 | 1.39 ± 0.33 |
| P18 | 7.22 ± 0.11 | 9.25 ± 0.15 |
| P20 | 7.85 ± 0.41 | 13.5 ± 1.03 |
| P22 | 6.94 ± 0.13 | 15.3 ± 0.06 |
| P25 | 9.30 ± 0.82 | 15.4 ± 0.81 |
| P28 | 10.5 ± 0.64 | 18.2 ± 0.39 |

^{a} This represents the highest force recorded during the experiment and obtained from the force versus displacement figure.

Initially, the P18 membrane exhibited the lowest EAB of only 7.22±0.11%, despite sharing the same material composition as the base membrane (i.e., an 18 wt. % PES solution). Nevertheless, the mechanical properties of the patterns were compromised due to the cavities formed within the patterns, as is evident in the cross-sectional SEM images. Macrovoids and cavities can be formed easily in low-viscosity polymer blends. The P20 and P22 membranes demonstrated slightly higher EAB values of ˜7.85±0.41% and 6.94±0.13%, respectively (Table 2). This EAB value escalates as the viscosity of the 3D printing solution increases in the P25 and P28 membranes, leading to the suppression of the finger-like structure and the promotion of a sponge-like structure within the membrane sublayer skeleton. This alteration enhances the mechanical properties of the membrane as also reported in the literature. Furthermore, an increase in porosity generally correlates with a reduction in the membrane's mechanical strength, including its EAB. This relationship arises from the presence of more void spaces within the membrane structure at higher porosities, which can act as sites for stress concentration and initiation of cracks or fractures under an applied load. Consequently, the membrane becomes more prone to deformation and failure, resulting in lower mechanical properties. As observed earlier in the magnified SEM images of the surface patterns shown in FIG. 5, the surface porosity decreases with the increase in the polymer concentration in the 3D printing solution. This contributed to improved mechanical properties of the surface-patterned membranes, as summarized in Table 2. For example, the P18 membrane, with a surface porosity of 3.84±0.21%, displayed an EAB of 7.22±0.11% and a peak applied force of 9.25±0.15 N, while the P28 membrane, with significantly lower surface porosity of 0.69±0.17%, showed higher values of 10.5±0.64% EAB and 18.2±0.39 N peak applied force. It is noteworthy to highlight that the increase in mechanical strength [i.e., peak applied force (N)] observed in the integrated membranes, in contrast to the flat membrane (F18), may be attributed to the thicker feed spacer patterns, as shown in FIG. 8C.

The TGA analysis of the fabricated membranes reveals a distinctive weight loss occurring primarily in two stages, as depicted in FIG. 8B. The initial weight loss, occurring at temperatures below 300° C., can be ascribed to the evaporation of entrapped water molecules and residual solvents. This weight loss is notably pronounced in the integrated membranes and is potentially linked to the presence of feed spacer patterns that facilitate a greater accumulation of entrapped water molecules and solvents within the patterns. Consequently, this leads to a higher weight loss below 300° C. The second weight loss is observed at Ta of 518° C. in the case of F18 membrane and 516, 499, 491, 456, and 432° C. in the case of P18, P20, P22, P25, and P28, respectively. This weight loss is associated with the degradation of the PES polymer chains, leading to the release of volatile products and the subsequent weight loss. Further degradation beyond this temperature is related to the further degradation of the PES polymer backbone. The slight reduction in the Td in the case of the integrated membranes may be related to the higher accumulation of solvent molecules in the patterns, which can alter the overall PES polymer chain strength. Nevertheless, the integrated membranes exhibit thermal stability, rendering them suitable for actual and reliable operations.

### Pressure Drops Across the Feed Channel.

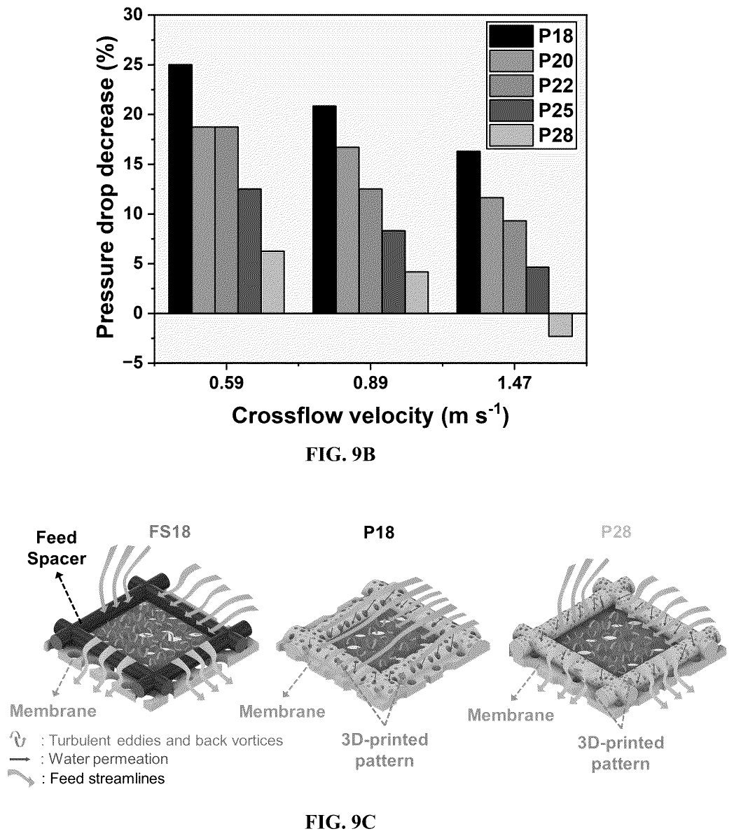

The pressure decline throughout the feed channel is of utmost importance in membrane filtration systems since it is linked to the energy consumption associated with the filtration process. As shown in FIG. 9A, the pressure drop across the feed channel increases with an increase in the crossflow velocity in both the FS18 and integrated membranes with porous PES feed spacers. It is widely known that a pressure drop is inevitable when using spacers, stemming from the obstructions created by the feed spacers that impede the flow of incoming fluid. Nevertheless, minimizing this pressure drop holds significant importance for the sustainability of water treatment processes. In FIG. 9A, the greatest pressure drop is evident in the FS18 membrane, utilizing a plastic 3D-printed PLA feed spacer. In contrast, the integrated membranes exhibit a notable 6.25-25.0% reduction in pressure drop compared to the FS18 membrane at a crossflow velocity of 0.59 m s⁻¹, as shown in FIG. 9B. The most substantial reduction in pressure drop is observed in the P18 membrane, primarily attributable to the flattening of the patterns, leading to lower pattern fidelity. This flattening diminishes the obstructions encountered by the fluid as it traverses between the inlet and outlet within the feed channel. It facilitates a smooth flow of fluid streamlines over the patterns, minimizing the formation of turbulent eddies and back vertices, as depicted in FIG. 9C.

Conversely, elevating pattern fidelity, driven by the heightened viscosity of the 3D printing solution, induces the fluid streamlines to split and merge within the interspace between the patterns. This leads to the production of many turbulent eddies and vortices, resulting in the formation of areas with reduced pressure and presenting extra challenges for the water to maneuver around the patterns. This phenomenon causes a deceleration in the fluid flow, ultimately resulting in elevated pressure drops. However, the prevalence of turbulent eddies in the FS18 membrane exceeds that in the integrated membranes, including those with the highest feed spacer pattern definition, such as the P25 and P28 membranes (FIG. 9C). The difference in results may be explained by the permeable nature of these patterns, which allows water to permeate, thereby decreasing fluid resistance. This leads to a decrease in drag since the porous patterns provide a consistent velocity at their surfaces, which in turn delays the separation of fluid and promotes the formation of turbulent boundary layers on the patterns. A turbulent boundary layer retains more kinetic energy than a laminar boundary layer, resulting in a lower shear stress at the interface between the fluid and the surface. This leads to reduced pressure and frictional drags. These interactions result in a decrease in the presence of turbulent eddies in the area between the patterns, eventually causing a decrease in pressure drop (FIG. 9C). This phenomenon exhibits diminishing efficacy at higher crossflow velocities, elucidating the negligible reduction in pressure drop at elevated rates. In some instances, such as in the case of the P28 membrane, there is even an observed increase in pressure drop compared to the FS18 membrane at a crossflow velocity of 1.47 m s⁻¹, as illustrated in FIG. 9B.

### Antifouling Performance and Membrane Durability.

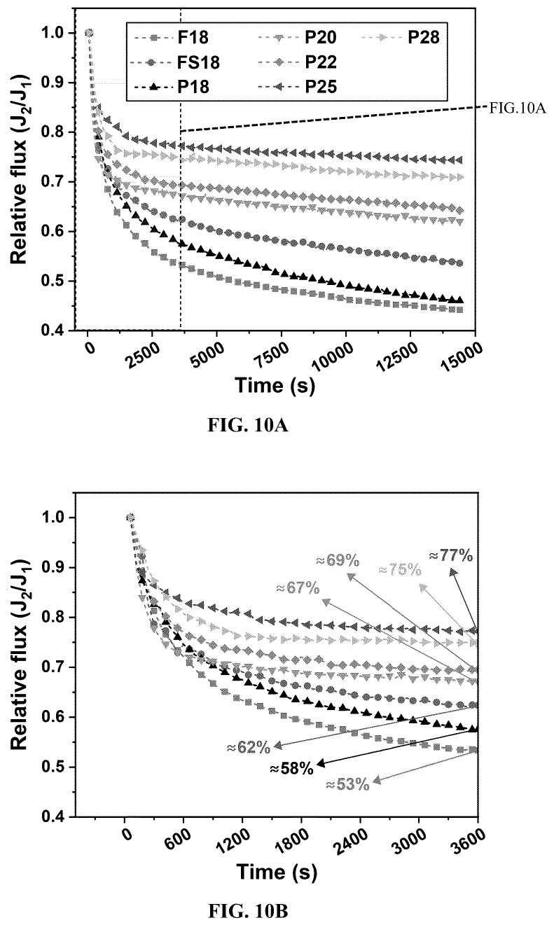

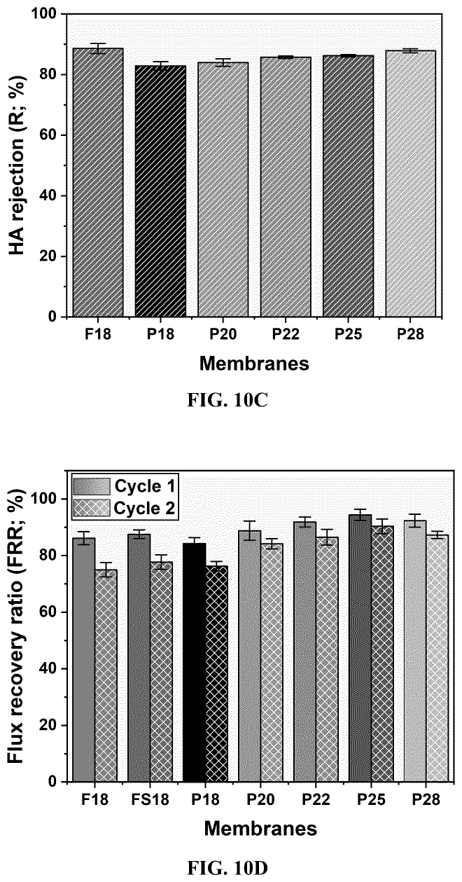

HA solution served as the model foulant for assessing the antifouling efficacy of the fabricated membranes. This evaluation involved measuring the flux decline over a 4.00 h HA filtration (FIG. 10A). The findings revealed a greater fouling propensity in the flat PES membrane (i.e., F18 membrane) in contrast to both the FS18 and integrated membranes. For instance, during the initial hour of operation, the F18 membrane exhibited a flux decline of ˜46.7%, while the FS18, P18, P20, P22, P28, and P25 membranes demonstrated comparatively lower declines at ˜37.7, 42.4, 32.9, 30.6, 25.3, and 22.8%, respectively (FIG. 10B). As the filtration experiment progressed, the F18 membrane experienced a further decline, reaching ˜55.8%, in contrast to the FS18, P18, P20, P22, P28, and P25 membranes, which showed declining fluxes of ˜46.4, 53.9, 38.1, 35.8, 29.1, and 25.6%, respectively. This fouling behavior suggests that the membrane fouling initiates with pore blockage and subsequently progresses due to the additional formation of a cake layer on the membrane surface. This phenomenon is particularly pronounced in the F18 membrane as it lacks any effective mechanism to combat the formation of such a cake layer on the membrane surface. Conversely, when employing a 3D-printed PLA feed spacer, turbulence is induced in the interspace between the spacer filaments, as illustrated in FIG. 11. When employing a feed spacer or surface patterns to combat membrane fouling, the prevailing antifouling mechanisms often involve either turbulence-driven or shear stress-driven fouling resistance (FIG. 11). In the earlier, the incoming feed stream divides into multiple streams around the spacer and pattern, then reunites in the interspace between the patterns/spacer filament, giving rise to turbulent eddies and back vortices. This turbulence disrupts the interaction between HA foulants and the membrane surface, diminishing the deposition of HA foulants on the membrane. Additionally, it aids in pushing back the HA foulants into the bulk solution, as depicted in the schematic illustration in FIG. 11. Furthermore, the presence of surface patterns, resembling the geometry of the feed spacer, induces a similar turbulence, further contributing to reduced membrane fouling. Nevertheless, with decreasing pattern fidelity, the efficacy of this turbulence diminishes, leading to a decline in membrane antifouling performance. This is exemplified by the P18 membrane, which exhibited a fouling behavior comparable to the F18 membrane, despite possessing flattened surface patterns. Additionally, the P18 patterns featured the largest pore size among the integrated membranes, facilitating the rapid attachment of HA foulants within the membrane pores. This quick attachment serves as initiation sites for subsequent HA deposition and build-up, contributing to more irreversible fouling. Membranes characterized by larger pore sizes are susceptible to a more pronounced initial decline in flux as opposed to membranes with smaller pore sizes. Moreover, with an increase in pattern fidelity, the antifouling efficacy of the integrated membranes is enhanced, due to the improved turbulence generated in the interspace between the patterns.

Another contributing factor to the superior antifouling performance of the integrated membranes with the porous PES feed spacer, compared to the traditional non-porous PLA feed spacer (i.e., FS18 membrane) with a flat surface, is the heightened shear stress exerted on the patterns themselves. The presence of shear stresses is evident on the peaks of the traditional feed spacers, as depicted in FIG. 11, owing to the no-slip condition. However, the advantages of such stresses remain underutilized due to the non-porous nature of the PLA spacer. In contrast, with an integrated and porous PES feed spacer, these shear stresses actively contribute to the removal of foulants from the patterns (i.e., integrated feed spacer), maintaining this area as relatively clean for water filtration. Consequently, membrane fouling is significantly mitigated, as illustrated in FIG. 10A. Interestingly, the P28 membrane, despite having higher pattern fidelity than the P25 membrane and a smaller pore size, exhibited slightly lower antifouling performance. This discrepancy could be attributed to the significantly lower surface porosity of the patterns on the membrane, potentially accelerating the blockage of pores by HA foulants due to the reduced number of surface pores and consequently exacerbating membrane fouling.

The fabricated membranes underwent testing for HA removal efficiency, and the results are illustrated in FIG. 10C. Notably, the F18 membrane exhibited the highest HA removal at 88.6±1.68%, while the P18 membrane showed the lowest HA removal at 82.8±1.39%. This removal efficiency demonstrated an increase with the rising viscosity of the 3D printing solution, attributed to the reduced demixing rate that results in a smaller pore size, as discussed and observed earlier in the SEM images. The P20, P22, P25, and P28 membranes reported HA removal of 83.9±1.21, 85.7±0.42, 86.2±0.36, and 87.8±0.64%, respectively (FIG. 10C). These outcomes suggest the successful integration of surface patterns into the flat PES membrane without significant compromise to HA removal.

The FRR values for the integrated membranes, excluding the P18 membrane, surpass those of the F18 and FS18 membranes. For instance, following 2 cycles of HA filtration, the P20, P22, P25, and P28 membranes exhibited FRR values of 84.1±1.80, 86.5±2.78, 90.3±2.59, and 87.2±1.31%, respectively (FIG. 10D). In contrast, the F18, FS18, and P18 membranes demonstrated FRR values of 74.9±2.52, 77.7±2.54, and 76.4±1.65%, respectively (FIG. 10D). As previously discussed, the peaks of the patterns in the integrated membranes often experience high shear stresses due to the no-slip condition. These heightened shear stresses minimize the deposition of HA foulants on these surfaces, thereby shielding them from severe membrane fouling. This underscores the high antifouling capabilities of the integrated membranes when compared to flat membranes, whether with or without the use of PLA feed spacers. Nevertheless, it is noteworthy that the recovered pure water flux decreased in all fabricated membranes, indicating an increased percentage of irreversible fouling, as commonly observed in studies within the literature.

### CONCLUSIONS

Integrated membranes featuring a porous PES feed spacer were fabricated using direct 3D printing technology. Various concentrations of PES polymer (18, 20, 22, 25, and 28 wt. %) were employed in the 3D printing solution to scrutinize the impact of solution viscosity on 3D-printed pattern fidelity and overall membrane performance. For comparative analysis, the FS18 membrane, comprising a 3D-printed plastic PLA feed spacer and a flat PES membrane, served as a benchmark in the evaluation process. The findings underscored that integrated membranes with porous PES feed spacers can substantially enhance pure water flux by 31.0-130%, compared to the utilization of traditional plastic feed spacers. This enhancement primarily stems from the augmented effective surface area available for water filtration due to the presence of porous patterns resembling the shape of traditional feed spacers. However, the degree of this enhancement is notably dependent on the viscosity of the 3D printing solution. For instance, the P18 membrane, fabricated with a low-viscosity 3D printing solution, exhibited significantly reduced pattern fidelity as the patterns tended to flatten during the 3D printing process. This resulted in an overall less effective membrane in nearly all of the conducted tests evaluating membrane performance.

The integrated membranes, excluding the P18 membrane, demonstrated superior antifouling performance over the flat PES membrane, with or without the use of a plastic feed spacer. This improved performance can be attributed to the elevated shear stress typically present on the peaks of these porous patterns, acting as a protective shield against severe membrane fouling. Furthermore, the patterns effectively induce turbulence in the interspace between the patterns, akin to the traditional feed spacer's role which facilitates the diversion of HA foulants from the surface of the membrane. In summary, this disclosure underscores the efficacy of employing direct 3D printing technology to seamlessly integrate porous feed spacers into membrane surfaces. This innovative approach offers a promising avenue for combating membrane fouling and enhancing water permeation in UF membranes. It also opens paths for further optimization of this technique and encourages exploration of the utilization of a wide range of other polymers and pattern configurations in the 3D printing process.

The introduction of integrated PES feed spacers resulted in a substantial increase in pure water flux across various PES concentrations in the 3D printing solution. For instance, membranes fabricated with a PES concentration in the 3D printing solution of 25 wt. % exhibited a pure water flux of 72.6 liters per square meter per hour (L m⁻² h⁻¹), which is approximately 2.9 times higher than that of the flat PES membrane at 25.1 L m⁻² h⁻¹, and 2.3 times higher than the conventional membrane with plastic and non-porous feed spacer at 31.6 L m⁻² h⁻¹.

The effective surface area available for filtration was significantly increased through the integration of feed spacers. For example, membranes fabricated with a PES concentration in the 3D printing solution of 25 wt. % demonstrated a 35.3% larger effective surface area compared to the flat membrane. This enhancement in surface area is directly correlated with the improved water flux observed. Additionally, the use of porous feed spacers instead of non-porous feed spacers contributes to the increase in effective surface area as the presence of pores increases available surface area.

Mechanical testing revealed enhanced durability of the integrated membranes, with the membrane fabricated with a PES concentration in the 3D printing solution of 25 wt. % membrane demonstrating an elongation at break of 9.30±0.82%, and a peak applied force resistance of 15.4±0.81 N, signifying a robust mechanical structure. Thermal analysis indicated that the integrated membranes-maintained stability up to temperatures of ˜400° C., ensuring reliability under operational conditions.

The integrated membrane exhibited superior antifouling performance of the flat membrane with and without the use of plastic and non-porous feed spacer. For instance, at the end of 4-hours fouling experiment, the integrated membrane exhibited 25.6% flux decline compared to 46.5 and 55.8% in the case of the flat membrane with and without the use of the plastic and non-porous feed spacer, respectively. This superior antifouling performance of the integrated membranes is mainly attributed to the shear stress-driven fouling resistance that forms on the feed spacers patterns.

These results unequivocally demonstrate that the integration of porous and permeable PES feed spacers onto membrane surfaces, a method never before implemented, significantly enhances water filtration performance. The integration of these feed spacers onto membrane surfaces leads to increased pure water flux, augmented surface area, superior antifouling capabilities, and reinforced mechanical and thermal stability, marking a significant step forward in membrane technology. By pioneering the direct 3D printing of PES feed spacers onto membrane surfaces, this work opens new doors for the development of advanced filtration systems. It not only sets a new benchmark for membrane performance but also lays the groundwork for future innovations in membrane design and functionality, promising a new era of efficiency and effectiveness in water treatment technologies.

### Definitions

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) can include or exclude intermediate values within the range of values (e.g., W1 to W2 can include only W1 and W2, etc.).

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

As used herein, the terms “coupled,” “connected,” and the like mean the joining of two additional intermediate members being integrally formed as a single unitary body with one another or with the two members or the two members and any additional intermediate members being attached to one another.

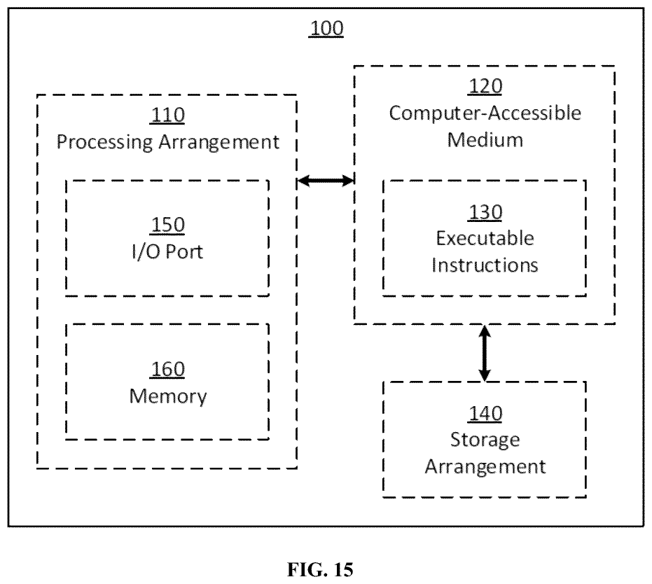

As shown in FIG. 15, e.g., a computer-accessible medium 120 (e.g., as described herein, storage members directly or indirectly to one another. Such joining may be stationary (e.g., permanent) or moveable (e.g., removable or releasable). Such joining may be achieved with the two members or the two members and any device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example. The instructions may include a plurality of sets of instructions.

System 100 may also include a display or output device, an input device such as a keyboard, mouse, touch screen or other input device, and may be connected to additional systems via a logical network. Many of the embodiments described herein may be practiced in a networked environment using logical connections to one or more remote computers having processors. Logical connections may include a local area network (“LAN”) and a wide area network (“WAN”) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method for integrating a feed spacer onto a membrane comprising:
providing a polymeric membrane consisting of one or more polymers;
submerging the polymeric membrane in a first coagulation bath; and
three-dimension (3D) printing a feed spacer onto the polymeric membrane forming an integrated membrane, the feed spacer comprising at least one of the one or more polymers of the polymeric membrane.

2. The method of claim 1 wherein 3D printing comprises a printing solution having a polymer concentration between 18 wt. % and 28 wt. %, inclusive.

3. The method of claim 1, wherein the first coagulation bath comprises at least one of water, alcohol, aqueous salt solutions, and polar aprotic solvents.

4. The method of claim 1, wherein the first coagulation bath comprises water and isopropyl alcohol and the 3D printing occurs while the polymeric membrane is immersed in a second coagulation bath comprising isopropyl alcohol.

5. The method of claim 1, further comprising immersing the integrated membrane into a third coagulation bath after 3D printing, the third coagulation bath comprising water and isopropyl alcohol.

6. The method of claim 5, further comprising immersing the integrated membrane into a fourth coagulation bath for a second time, the second time longer than a time for immersing the integrated membrane into the third coagulation bath, the fourth coagulation bath comprising pure water.

7. A method for fabricating an integrated membrane comprising:
fabricating a polymer membrane comprising a polymer;
submerging the polymer membrane in a first coagulation bath; and
three-dimension (3D) printing a porous feed spacer, to form the integrated membrane, directly onto the polymer membrane while the polymer membrane is in a coagulation bath.

8. The method of claim 7, wherein the first coagulation bath comprises at least one of water, alcohol, aqueous salt solutions, and polar aprotic solvents.

9. The method of claim 7, wherein a printing solution is used for 3D printing the porous feed spacer, the printing solution comprising the polymer.

10. The method of claim 7, wherein fabricating the integrated membrane includes a phase separation method utilizing non-solvent induced phase separation, and the phase separation method comprises:
casting a polymer blend comprising the polymer onto a supporting material; and
submerging the polymer membrane in a second coagulation bath to initiate phase separation, the second coagulation bath comprising isopropyl alcohol and pure water, and a volume ratio of the pure water and isopropyl alcohol in the second coagulation bath is 25:75.

11. The method of claim 7, wherein the polymer is polyethersulfone, polyvinylidene fluoride, polysulfone, polyethylene, or polypropylene.

12. The method of claim 7, wherein the porous feed spacer has a pattern, the pattern being square, zigzag, diamond, or honeycomb.

13. The method of claim 7, wherein the first coagulation bath comprises pure water and isopropyl alcohol, a volume ratio of the pure water and isopropyl alcohol being 25:75.

14. The method of claim 7, further comprising immersing the integrated membrane for a first time into a third coagulation bath after printing, the third coagulation bath comprising ultrapure water and isopropyl alcohol having a volume ratio of 25:75, respectively.

15. The method of claim 14, further comprising immersing the integrated membrane into a fourth coagulation bath for a second time, the second time longer than the first time, the fourth coagulation bath comprising pure water.

16. An integrated membrane comprising:
a polymer membrane comprising a polymer; and
a porous feed spacer printed onto the polymer membrane while the polymer membrane and the porous feed spacer comprise at least one polymer in common.

17. The integrated membrane of claim 16, wherein the porous feed spacer consists of the polymer of the polymer membrane.

18. The integrated membrane of claim 16, wherein the polymer has a concentration that is between 18 wt. % and 28 wt. %, inclusive.

19. The integrated membrane of claim 16, wherein the integrated membrane is submerged in a first coagulation bath comprising at least one of water, alcohol, aqueous salt solutions, and polar aprotic solvents.

20. The integrated membrane of claim 19, wherein the first coagulation bath comprises isopropyl alcohol and pure water, a volume ratio of the pure water and isopropyl alcohol being 25:75.
